(19) United States
(12) Patent Application Publication
(10) Pub. No.: US 2004/0032562 A1
(43) Pub. Date: Feb. 19, 2004

(54) Method and apparatus for adjusting contrast during assembly of liquid crystal displays and similar devices

(75) Inventors: Edward William Lindblad, Scottsdale, AZ (US); Randall Jay Glinski, Glendale, AZ (US)

Correspondence Address: Timothy J. Lorenz, INGRASSIA, FISHER, & LORENZ, P.C., 7150 E. Cambelback Road, Scottsdale, AZ, 85251, US

(73) Assignee: Three-Five Systems, Inc.

(21) Appl. No.: 09/846,582

(22) Filed: May 1, 2001

(51) Int. Cl. G02F 1/13

(52) U.S. Cl. 349/187

(57) ABSTRACT

An apparatus and method for altering a contrast of an as-manufactured LCD device is described. The LCD device includes a contrast-setting circuit and a printed circuit flex. During the assembly process, a shunt around a resistor in a voltage divider subcircuit of the contrast-setting circuit extends onto a portion of the printed circuit flex. Due to the shunt, the resistor is initially in a shorted state such that the resistor does not influence the contrast-setting circuit. During a stage of the assembly process, a current contrast of the liquid crystal display device is determined. If the current contrast deviates from an intended contrast, the portion of the printed circuit flex is severed from the rest of the printed circuit flex such that the resistor becomes unshorted and thereby influences the contrast-setting circuit to provide a contrast closer to the intended contrast.

### FIELD OF THE INVENTION

The present invention relates to liquid crystal displays and, more particularly, to the manufacture of liquid crystal displays.

### BACKGROUND INFORMATION

Liquid crystal displays (LCDs) and, in particular, liquid crystal on silicon (LCoS™) displays are being produced in relatively large volumes to meet an increasing demand. In particular, passive matrix LCDs are experiencing a resurgence in demand for use with low-power, portable devices, such as handheld telephones or personal digital assistants (PDAs). However, the marketplace is placing increasing demands on quality of display to satisfy the latest technological advances, such as text messaging and mobile Web access. The latest implementations for passive matrix LCDs make use of higher multiplex rates than had been seen in the past. The multiplex rate is the rate at which each line is addressed in the rectangular array of a passive matrix LCD. Although higher multiplex rates can lead to greater resolution and display performance, they also exacerbate the problem of process variations in the manufacture of the displays.

In particular, process variations during the manufacture of passive matrix displays often result in higher-than-acceptable tolerances for some operating parameters of the displays. For instance, the contrast of many passive matrix displays is controlled by a regulator and a voltage divider circuit the output value of which is dependent on a ratio of generally two resistors. In a production environment, if the regulator, LCD operating tolerance and values of the resistors in the voltage divider circuit vary in excess of some determinable threshold, the difference in contrast from part-to-part is usually significant, to the extent that some customers may complain that the displays are not uniform enough. Until now, there has been no workable solution to that problem.

One attempt to address the problem was to make software adjustments to the contrast after the entire device has been assembled. However, the use of software as an attempt to individually adjust the contrast of LCDs is viewed as extremely labor intensive and cost inefficient. Another attempted solution was to actually replace one or more resistors in the contrast-setting voltage divider circuit during the manufacturing process. As can be appreciated, testing each LCD during manufacturing in order to manually replace a resistor on the device is also extremely cost inefficient and labor intensive. Thus, neither of those two attempts offers an efficient, cost effective, or workable solution to the problem of part-to-part contrast variance in passive matrix LCDs. Accordingly, there is a need in the art for just such a solution.

### SUMMARY

In accordance with aspects of the present invention, a LCD manufacturing system is provided for use in a high volume production environment. Briefly stated, the invention enables a contrast of an LCD device to be altered during the manufacturing process by determining a current contrast of the LCD device, and then altering a contrast-setting circuit by removing a short around one or more components of the contrast-setting circuit to alter the output of the contrast-setting circuit, thereby altering the as-manufactured contrast of the LCD device.

In one aspect, the present invention provides a method for manufacturing an LCD device that includes a contrast-setting circuit and a printed circuit flex. During the assembly process, at least a portion (e.g., a shunt around a resistive component in a voltage divider subcircuit) of the contrast-setting circuit extends onto a portion of the printed circuit flex. The resistive component of the contrast-setting circuit may be initially in a shorted state such that the resistive component does not influence the contrast-setting circuit. During a stage of the assembly process, a current contrast of the liquid crystal display device may be determined. If the current contrast deviates from an intended contrast, the portion of the printed circuit flex is altered such that the resistive component of the contrast-setting circuit becomes unshorted and thereby influences the contrast-setting circuit to provide a contrast closer to the intended contrast.

In another aspect, an LCD device includes a contrast-setting circuit for setting a contrast of an LCD panel associated with the LCD device. The contrast setting circuit includes a regulator and a voltage divider circuit having an output voltage determined by a ratio of a first resistive subcircuit to a second resistive subcircuit. The second resistive subcircuit includes at least two resistive components. At least one of those resistive components is initially shorted such that it initially provides an insignificant amount of influence on the voltage divider circuit. However, when a shunt associated with the resistive component is severed, the at least one resistive component influences the voltage divider circuit such that the final contrast of the LCD device is altered.

Advantageously, the present invention allows the contrast of the LCD device to be physically altered during the manufacturing process without a need to remove or otherwise replace components of the LCD device. In this way, the present invention greatly compensates for variances in glass (LCD cell), driver, and other component tolerances which may otherwise result in undesirable part-to-part contrast variations for the LCD devices.

### BRIEF DESCRIPTION OF THE DRAWINGS

FIG. 1 is a basic circuit diagram of a contrast-setting voltage divider circuit that implements one embodiment of the present invention;

FIG. 2 is a perspective view of one illustrative LCD device capable of having the contrast of the display set during the manufacturing process, in accordance with the present invention;

FIG. 3 is a detailed view of the printed circuit flex illustrated in FIG. 2 detailing the stubs; and

FIG. 4 is a perspective view of a finished LCD device manufactured in accordance with the present invention and implementing a contrast-setting mechanism in accordance with the present invention.

### DETAILED DESCRIPTION

In a high volume LCD production environment, the inventors of the present invention have appreciated that it is advantageous to be able to physically adjust the contrast of an LCD during the production process. As used herein, LCD includes LCoS™ devices available from Three-Five Systems, Inc., Tempe, Ariz. Accordingly, the inventors have devised a system and mechanism which allows the contrast-setting voltage divider circuit of an LCD to be adjusted without removing or replacing components of the circuit. Briefly stated, a contrast-setting voltage divider circuit includes additional components, such as resistors, which are originally shorted until a testing stage of the production. During the testing stage, the LCD is powered on and its voltage is measured. Based on that measurement, a trimming tool is used to “unshort” (e.g., by severing a shunt or trace that shorts a resistor) one or more of the additional components to alter the resistance ratio of the voltage divider, and thereby fine-tune the contrast of the display.

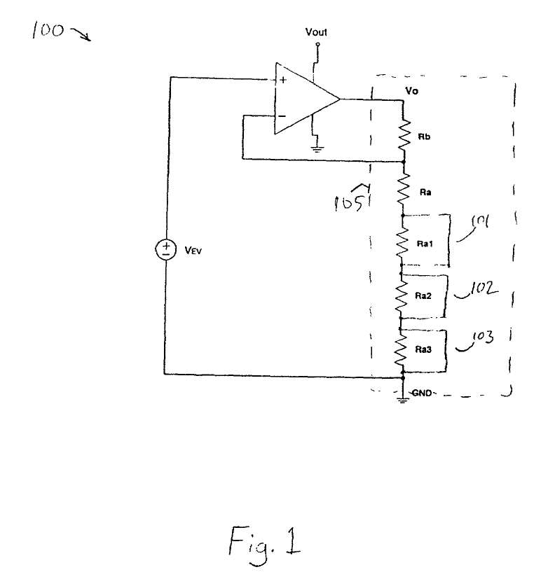

FIG. 1 is a basic circuit diagram of a contrast-setting voltage divider circuit 100 that implements one embodiment of the present invention. In general, a regulation voltage V_{EV} drives a voltage regulator circuit having an output voltage V_{O}. The output voltage V_{O} sets the contrast of the LCD panel. The output voltage V_{O} is determined by the voltage divider subcircuit 105 made up of series connected resistors Rb and Ra as well as the series connected supplemental resistors Ra1, Ra2, and Ra3. The ratio of resistor Rb to the combination of the other resistors (Ra, Ra1, Ra2, and Ra3) sets the value of the output voltage V_{O} with respect to the regulation voltage V_{EV}. It will be appreciated that supplemental resistors Ra1, Ra2, and Ra3 are initially short-circuited by shunts 101, 102, 103, thereby providing no influence on the voltage divider subcircuit 105. Thus, the initial output voltage V_{O} is determined only by the ratio of resistor Rb to resistor Ra. As is described more fully later, one or more of the supplemental resistors Ra1, Ra2, Ra3 may be unshorted by severing one or more of the shunts 101, 102, 103 that short those resistors.

The components of the circuit 100 are designed so that the output voltage V_{O} has a particular value. However, those skilled in the art will appreciate that in a manufacturing environment, the particular components that are actually assembled have tolerances which typically result in variations in the as-manufactured output voltage V_{O}. For example, the regulation voltage V_{EV} may vary by as much as 3% from manufactured part to manufactured part. The values of the voltage divider resistors may also vary by as much as 1%. Together, those tolerances could cause the exact value of the output voltage V_{O} to deviate noticeably from part to part, thus resulting in a noticeable contrast difference from part to part. However, in accordance with the teachings of the present invention, at some stage during the manufacturing process, the actual as-manufactured output voltage V_{O} is measured and adjusted by selectively unshorting one or more of the supplemental voltage divider resistors Ra1, Ra2, Ra3, such as by disconnecting one or more of the shunts 101, 102, 103. In that way, the influence of the voltage divider 105 on the entire circuit 100 may be selectively altered by choosing which of the supplemental resistors Ra1, Ra2, Ra3 to include in the circuit 100.

In this particular embodiment, the values of the supplemental resistors Ra1, Ra2, Ra3 are selected such that one resistor is twice the value of another resistor which is twice the value of the third resistor. For example, if the value of Ra1 is 1 K Ohm then Ra2 may be 2 K Ohm and Ra3 would be 4 K Ohm. That configuration allows the greatest control over the collective resistance of the combination of resistors Ra, Ra1, Ra2, and Ra3. Of course, other configurations, including other numbers of supplemental resistors, are equally applicable to the teachings of the present invention, as will be apparent to those of ordinary skill in the art.

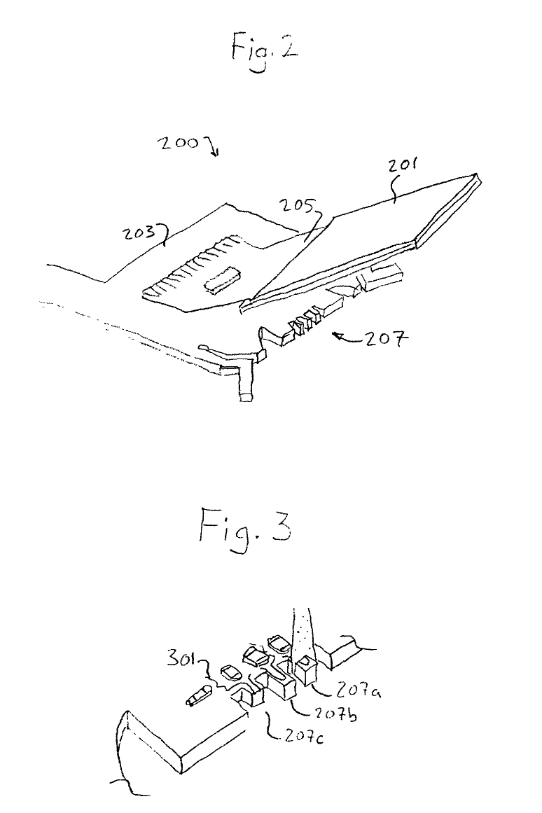

FIG. 2 is a perspective view of one illustrative LCD device 200 capable of having the contrast of the display set during the manufacturing process, in accordance with the present invention. As shown in FIG. 2, a passive matrix LCD 201 is attached to a printed circuit flex 203 by a tab 205. The printed circuit flex 203 contains the printed circuitry that controls the display on the LCD 201. A portion of that printed circuitry extends onto several stubs 207 on the printed circuit flex 203. More specifically, the shunts 101, 102, 103 (FIG. 1) may each extend onto one of the stubs 207. The stubs and traces are described in greater detail below in conjunction with FIG. 3.

FIG. 3 is a detailed view of the printed circuit flex 203 detailing the stubs 207a-c. As mentioned above, the printed circuit flex 203 contains stubs 207a-c that protrude out from the edge of the surface-mount component area, and on each stub 207a-c is a trace, such as trace 301, corresponding to the shunts 101, 102, 103 that short the supplemental resistors Ra1, Ra2, Ra3 (FIG. 1). The traces extend out onto a stub and return to the surface-mount component area, forming a small loop on the stub. In accordance with this embodiment of the invention, one or more of those traces may be selectively cut by severing its corresponding stub. As shown in FIG. 3, a blade 305 is used to cut stub 207a, thereby opening the corresponding trace. In that way, supplemental resistors that are shorted by those traces may be unshorted (and, hence, introduced into the contrast-setting circuit 100).

For example, assuming trace 301 corresponds to shunt 103 (FIG. 1), cutting stub 207c, which supports trace 301, opens the shunt 103 around supplemental resistor Ra3, thus adding the resistive influence of Ra3 to the voltage divider subcircuit 105, thereby affecting the contrast of the LCD device. In this way, the final ratio of the voltage divider subcircuit 105 may be easily tweaked during the manufacturing process, which allows the manufacturer greater control over the part-to-part contrast of each LCD device manufactured. The individual stubs 207a-c may be severed through any means capable of creating a disconnect the corresponding trace, such as by blade 305, punch, laser, or the like.

More specifically, referring now to FIGS. 1-3, at an appropriate stage during manufacturing, each LCD device, such as LCD device 200, is powered up and measurements are taken of the current contrast of the LCD device through any acceptable means. For example, voltage measurements may be taken of the output voltage V_{O} of the contrast-setting voltage divider circuit 100. Alternative means for measuring the current contrast may equally be used, such as a current monitor, an optical system, manual comparison, or the like.

Preferably, the voltage V_{O} will initialize to a value corresponding to the middle of the tolerance band. However, considering the subtle variations inherent in both passive component values and the driver IC itself, the actual voltage V_{O} may be higher or lower than expected. At initial power-up, the display is likely to be inherently overdriven, indicating that one or more of the supplemental resistors Ra1, Ra2, Ra3 should be introduced into the voltage divider circuit 105 to achieve an optimum ratio. By knowing both the effect of adding resistance to the circuit and the initial voltage rating, V_{O}, one can predict how much resistance must be added to the circuit 100 to achieve an ideal contrast setting. The inventors have experimented with various implementations of the invention and provide the following table to illustrate sample voltages that may be achieved at the output voltage V_{O} as a result of selectively adding resistance to the contrast-setting voltage divider circuit 100.

| Cut Pattern | | | Approximate Initial Voltage (Vo) |
|---|---|---|---|
| Ra1 | Ra2 | Ra3 | Vo (Volts) |
| 0 | 0 | 0 | 12.1 |
| 0 | 0 | X | 12.32 |
| 0 | X | 0 | 12.54 |
| 0 | X | X | 12.76 |
| X | 0 | 0 | 12.98 |
| X | 0 | X | 13.20 |
| X | X | 0 | 13.42 |
| X | X | X | 13.64 |

If the output voltage V_{O} is measured, the proper stubs 207a-c to cut can be determined based on the current value of the output voltage V_{O} and the change in ratio achieved by cutting each particular stub or stubs (as shown in the above table). For example, if the initial output voltage V_{O} measured a value of 13.20 volts, the table indicates that by cutting the stubs corresponding to resistors Ra1 and Ra3, the optimum output voltage V_{O} should be achieved, thereby resulting in a predictable contrast for the LCD device. It is envisioned that the tolerances for each part will result in slightly varied measured output voltages V_{O}, so, by selectively cutting the appropriate stub (or trace), an optimum value for the output voltage V_{O} may still be achieved from part-to-part.

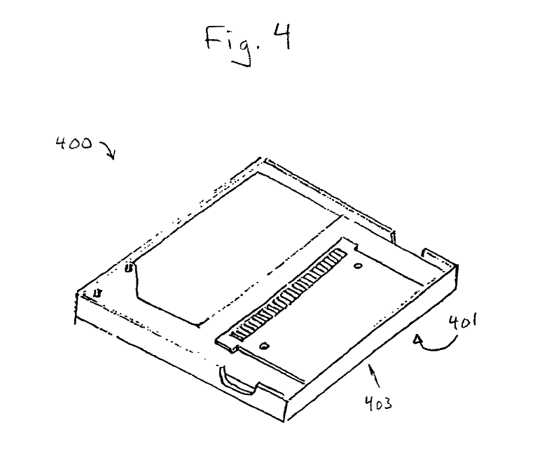

FIG. 4 illustrates a completed LCD device 400 manufactured in accordance with the present invention. The LCD device 400 shown has been manufactured in accordance with the process described above so that the contrast of the LCD panel 401 has been physically adjusted during the manufacturing process. Referring to both FIG. 2 and FIG. 4, it will be appreciated that the LCD device 400 may be assembled by wrapping the LCD panel 201 around the printed circuit flex 203, thereby covering the stubs 207 and forming a complete LCD package.

The present invention allows a manufacturer to achieve much lower tolerances and greater control over the contrast of LCD devices being mass produced. In particular, the present invention allows a manufacturer to greatly reduce the amount of manual labor involved in manufacturing LCD devices if the contrast were adjusted by replacing particular resistors. Moreover, the present invention also allows manufacturers to ensure their customers of a more consistent contrast from part-to-part without having to resort to software modifications, resistor binning, or the like.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for manufacturing a liquid crystal display device having a contrast-setting circuit and a printed circuit flex, comprising:
beginning assembly of the liquid crystal display device such that at least a portion of the contrast-setting circuit extends onto a portion of the printed circuit flex, the portion of the contrast-setting circuit having a first state and a second state, the first state being associated with a first adjustment of the contrast-setting circuit, the second state being associated with a second adjustment of the contrast-setting circuit; and
at a stage of the assembly of the liquid crystal display device:
testing a current contrast of the liquid crystal display device to determine an amount of deviation of the current contrast from an intended contrast, and
if the current contrast of the liquid crystal display device deviates from the intended contrast, modifying the portion of the printed circuit flex such that the portion of the contrast-setting circuit changes from the first state to the second state.

2. The method of claim 1 wherein the contrast-setting circuit further comprises a voltage divider including at least two components, the portion of the contrast-setting circuit being associated with one of the two components, the first state of the contrast-setting circuit being associated with the portion of the contrast-setting circuit causing the one component to be bypassed in the contrast-setting circuit.

3. The method of claim 2 wherein the second state of the contrast-setting circuit is associated with the portion of the contrast-setting circuit not causing the one component to be bypassed in the contrast-setting circuit.

4. The method of claim 3 wherein the at least two components comprise resistive components.

5. The method of claim 3 wherein the portion of the contrast-setting circuit comprises a shunt around the one component.

6. The method of claim 5 wherein modifying the portion of the printed circuit flex comprises altering the shunt such that the contrast-setting circuit changes from the first state to the second state.

7. The method of claim 6 wherein altering the shunt comprises severing a trace on the printed circuit flex.

8. The method of claim 1 wherein the portion of the printed circuit flex comprises a trace that acts as a shunt to short circuit a component of the contrast-setting circuit and wherein modifying the portion of the printed circuit flex comprises severing the trace.

9. The method of claim 8 wherein the contrast-setting circuit comprises a voltage divider subcircuit and wherein the component comprises a resistor within the voltage divider.

10. A LCD device manufactured in accordance with the method of claim 1.

11. A liquid crystal display (LCD) device, comprising:
a contrast-setting circuit for setting a contrast of an LCD panel associated with the LCD device, the contrast setting circuit including a voltage divider circuit having an output voltage determined by a ratio of a first resistive subcircuit to a second resistive subcircuit, the second resistive subcircuit including at least two resistive components, at least one of the resistive components having an initially shorted state such that the at least one resistive component initially provides an insignificant amount of influence on the voltage divider circuit, the at least one resistive component being configured to influence the voltage divider circuit when a shunt associated with the at least one resistive component is severed.

12. The LCD device of claim 11 wherein the shunt associated with the at least one resistive component has been severed, thereby adding the influence of the at least one resistive component to the voltage divider circuit.

13. The LCD device of claim 11 wherein the second resistive subcircuit further comprises at least four resistive components, at least three of the resistive components each having an associated shunt that initially short circuits each of the at least three resistive components.

14. The LCD device of claim 13 wherein the at least three resistive components each comprise a different resistive value.

15. The LCD device of claim 14 wherein a first of the different resistive values is an even multiple of another of the different resistive values.

16. The LCD device of claim 15 wherein the different resistive values increase in multiples of each lesser resistive value.

17. The LCD device of claim 11, further comprising a substrate on which resides the contrast-setting circuit, the substrate including a stub on which extends the shunt associated with the at least one resistive component, wherein severing the stub results in the shunt being severed.

18. The LCD device of claim 17 wherein the substrate includes another separate stub for each of the at least one resistive components.

19. The LCD device of claim 11 wherein the contrast-setting circuit resides in a printed circuit flex including a portion that is severable from the remainder of the printed circuit flex, the shunt extending onto the severable portion.

20. The LCD device of claim 19 wherein the printed circuit flex further comprises a plurality of portions that are severable from the remainder of the printed circuit flex, each of the plurality of portions being associate with a different of the at least one resistive components having the initially shorted state.
